(19) United States
(12) Patent Application Publication
(10) Pub. No.: US 2009/0113160 A1
(43) Pub. Date: Apr. 30, 2009

(54) Method and System for Reorganizing a Storage Device

(75) Inventor: Robert Laurence Ferraro, Myrtle Beach, SC (US)

Correspondence Address: BRUCE E. HAYDEN, P.C., P.O. BOX 205, DILLION, CO, 80435-0205, US

(73) Assignee: Disk Trix Incorporated, a South Carolina corporation, Myrtle Beach, SC (US)

(21) Appl. No.: 11/924,585

(22) Filed: Oct. 25, 2007

(51) Int. Cl. G06F 12/00

(52) U.S. Cl. 711/170; 711/E12.001

(57) ABSTRACT

A method and system for reorganizing a storage device such as a disk drive or partition thereof represents the storage device as a set of concentric circles, with each circle containing blocks of storage with the concentric circles having a differing numbers of blocks of storage resulting in differing radii of the concentric circles. More frequently used files are moved towards the outer circles with larger radii, and less frequently used, often archival, files are moved to the inner circles of lesser radius, all under user control. Additionally, the storage device is represented similarly as concentric circles of blocks of storage, with the blocks displayed potentially containing parts of multiple files, and files being contained in multiple blocks. Users can zoom in or out, with more or fewer blocks displayed.

### FIELD OF THE INVENTION

The present invention generally relates to computer software and, more specifically, to utility software for defragmenting and optimizing computer disk drives.

### BACKGROUND OF THE INVENTION

Hard disk drives have long been capable of storing multiple files on one disk. The need for disk space in a file can vary over time, with some disk files growing over time. One solution to this problem implemented by IBM Corporation for its mainframe computers was to require that users guess at the maximum size their files could grow, and then allocate that much space in advance. That was great for IBM, since it made as much money selling its disk drives as it did its computers. But it was less advantageous for its customers.

One solution to this problem of such an inefficient usage of disk drive space, especially at a time when disk drives were often more expensive than automobiles, was implemented by Sperry Univac for its mainframe computers, which allowed for dynamic file size by chaining file segments together. The operating system would attempt to allocate a new file in one piece, but if it could not do so, it would do so in pieces, logically chained together. It also allowed files to grow in size by chaining more file segments together. These file segments are hereinafter termed “fragments” and a file containing a plurality of such “fragments” is termed “fragmented”. Sperry implemented another feature that ultimately resulted in numerous fragmented files, and that was the ability to have files in its directories be actually located on backup storage, typically magnetic tape. Then, when a user requested access to such a file, it was “rolled in” to the hard drive, with other files “rolled out” to tape to make room. The problem was that, given the cost of disk drives at that time, they were often overcommitted, often with significantly more file space allocated than disk space was available. The result, as will be seen below, is that files often became significantly fragmented as they were allocated on almost full disk drives. The solution to this significant fragmentation problem was to roll a lot of files out to tape, creating large unallocated spaces on the disk drives, and then when the files were rolled back onto the disks, they would typically be less fragmented. This worked reasonably well for the time, but required significant operator assistance to make it work well.

The minicomputer revolution really got its start with the introduction of UNIX by AT&T. UNIX was essentially a stripped down version of Multics to run on much smaller systems. Almost from the first, UNIX provided for dynamic file sizes in a manner roughly analogous to the one utilized by Sperry Univac, of logically chaining file fragments together. And, thus, as a result, some systems experienced fragmented files. The solution to this problem was to reallocate a file as contiguously as possible, copy the data from the file being defragmented into the new file, and at the end, swap file descriptors, so that the file descriptors now addressed the new contents. This alleviated the problem some, but UNIX files were often quite fragmented.

The personal computer revolution was instigated by IBM creating a low cost computer system that operated under what ultimately became the Microsoft MS-DOC operating system. MS-DOS was a clone of a Digital Research operating system CP/M that was conceptually derived form UNIX. As a result, files early on were capable of dynamic growth, and again consisted of disk fragments logically chained together. Norton Speedisk discussed below was probably the premier defragmentation program designed for DOS file systems. A decade or so after the introduction of the personal computer, Microsoft introduced a more modern file architecture with its NT operating system, termed the NT File System (“NTFS”) which is the current file system currently run by the vast majority of computers in the world.

Previous defragmentation technologies have primarily focused on the fragmentation of files on the hard drive with little focus on the specific placement of files on the hard drive.

Microsoft Corporation has provided its customers a free defragmenter with their Windows operating system with its NT line of operating systems. The standard defragmenter included in Windows XP is quite rudimentary. It is a multipass defragmentation since it defragments files but does not fully consolidate the data and actually requires multiple passes to consolidate the data. The hard drive is typically left in a far from optimized state with considerable free space fragmentation and files placed on the drive in no particular order to achieve increased performance aside from the defragmentation of fragmented files.

The PerfectDisk defragmenter from Raxco aims to reduce subsequent defragmentation times and seek confinement. However does not perform any sorting of files. It merely segregates files based upon last access times but does not appear to attempt to consider the drive performance and does not explicitly seek to place files for high performance. U.S. Pat. No. 5,398,142 is an example of some of the technology implemented in PerfectDisk.

O&O Defrag is a defragmentation tool that provides a variety of sorting options but again does not seek to optimize seek confinement with all files being handled as a whole. This can result in long defragmentation times and sorting times.

Diskeeper is a defragmentation tool that does attempt to improve seek confinement and does segregate files based upon frequency of use. No particular sorting of files is done and files are merely segregated based upon frequency of use and rarely used files are placed at the slower inner tracks and frequently used files to the outer tracks.

Norton Speedisk is a defragmentation tool that attempts to categorize files based upon frequency of use and frequency of modification and layout files in an attempt to optimize file layout and reduce times for subsequent defrags. U.S. Pat. No. 7,124,272 is an example of some of the technology implemented in Speedisk.

One patent applications that show some different techniques for defragmenting disks is: U.S. Pat. No. 5,808,821 to William Davy titled: “Method for eliminating file fragmentation and reducing average seek times in a magnetic disk media environment”.

Nevertheless, the disk defragmenting products on the market right now have numerous weaknesses, including that they typically concentrate on defragging disks without optimizing disk performance, when they do try to optimize performance, they typically utilize less optimal paradigms, and their interfaces are misleading and inefficient.

### BRIEF SUMMARY OF THE INVENTION

A method and system for reorganizing a storage device such as a disk drive or partition thereof represents the storage device as a set of concentric circles, with each circle containing blocks of storage with the concentric circles having a differing numbers of blocks of storage resulting in differing radii of the concentric circles. More frequently used files are moved towards the outer circles with larger radii, and less frequently used, often archival, files are moved to the inner circles of lesser radius, all under user control. Additionally, the storage device is represented similarly as concentric circles of blocks of storage, with the blocks displayed potentially containing parts of multiple files, and files being contained in multiple blocks. Users can zoom in or out, with more or fewer blocks displayed.

### BRIEF DESCRIPTION OF THE DRAWINGS

FIG. 1 is a block diagram illustrating a General Purpose Computer;

FIG. 2 is a diagram of an exemplary hard drive, in accordance with the prior art;

FIG. 3 is a diagram illustrating an exemplary fragmented file and a contiguous file located on a hard drive;

FIG. 4 is a diagram illustrating an exemplary fragmented file and a contiguous file located on a hard drive;

FIG. 5 is a diagram illustrating exemplary ideal file placement on a hard drive;

FIG. 6 is a diagram that illustrates disk seeking;

FIG. 7 is a diagram that shows a typically hard drive that has not been optimized;

FIG. 8 is a diagram that illustrates the results of optimizing file placement on a disk drive utilizing Pareto's rule, in accordance with the current implementation of the present invention;

FIG. 9 is an exemplary diagram illustrating hard drive transfer performance;

FIG. 10 is an exemplary diagram that illustrates hard drive fatigue;

FIG. 11 is an exemplary diagram illustrating hard disk partitioning;

FIG. 12 is a diagram illustrating the main graphical interface of the current implementation of the present invention;

FIG. 13 is a diagram showing Volume Information, in accordance with the current implementation of the present invention;

FIG. 14 is a diagram that shows an Options screen that can be activated from the File Menu via the Tools submenu shown in FIG. 12;

FIG. 15 is a diagram showing an exemplary file selection page used to select High Performance files, in accordance with the current implementation of the present invention;

FIG. 16 is a diagram showing an exemplary file selection page used to select Archive files, in accordance with the current implementation of the present invention;

FIG. 17 is a diagram illustrating the defragmentation controls shown in FIG. 12 in more detail; and

FIG. 18 is a diagram illustrating an Options screen that is launched when a user clicks on one of the Defrag Method option buttons shown in FIG. 17.

### DETAILED DESCRIPTION OF THE INVENTION

The present invention comprises revolutionary defrag software that not only lets a user defrag, but also considers a more important phenomenon, and that is, the placement of files and folders on his hard drive. With the present invention the user can place the files he wants the best performance from onto the faster areas of his hard drive and also get all of his unused data right out of the way and repositioned onto the slower areas of his hard drive in order to make way for the data that he wants to place in the “hot” sections of his hard drive where performance is greatest.

The present invention lets the user specify defrag routines right down to the individual file and folder level. No other defragger has previously enabled users to do this to this extent and with this kind of power and flexibility.

The present invention has a High Performance file section option so that users can get the best possible performance out the programs they want the best performance from, whether it's a particular game, program or data file. They can move these programs and files ahead of other files and folders to the area of their drive that gives you the best performance.

Users choose the files that they want performance from and those that they don't or let the present invention do it for you—automatically based on file usage.

The present invention is very powerful yet very easy and intuitive to use. Once someone understands the basic concepts and issues that slow their hard drive and principles that result in increased performance, they can use the present invention as a powerful tool to give their hard drive file access that will perform significantly faster than what hard drive manufacturers quote for their hard drive's performance.

When done right—these principles of performance promotion, that the present invention enables users to address, all compound like magic to give them performance that they have not previously experienced from their hard drive. After defragging and optimizing with the present invention—their whole PC will respond with the speed and sprite as when it was new. They will see the performance results instantly!

If users decide that they do not want to use all of the advanced options and simply want a fast reliable defrag, then they can also use the present invention for that purpose only. Simply select the AUTO option and they will be enjoying what is probably the fastest and cleverest defrag engine on the market even with its approach to standard defragging which uses efficient “in-place” defragging algorithms for fast, reliable and complete defrags.

The present invention preferably utilizes Last Access time stamps for files to determine file usage frequency. For this purpose it is suggested that users have Last File Access time stamping enabled. By default in the current Windows operating systems, this is already set to enabled. Some programs and published Windows tweaks suggest that users disable it due to performance issues. In most circumstances the performance difference is unnoticeable however to get the performance increases that the present invention provides and for the present invention to function properly it is suggested that users enable it.

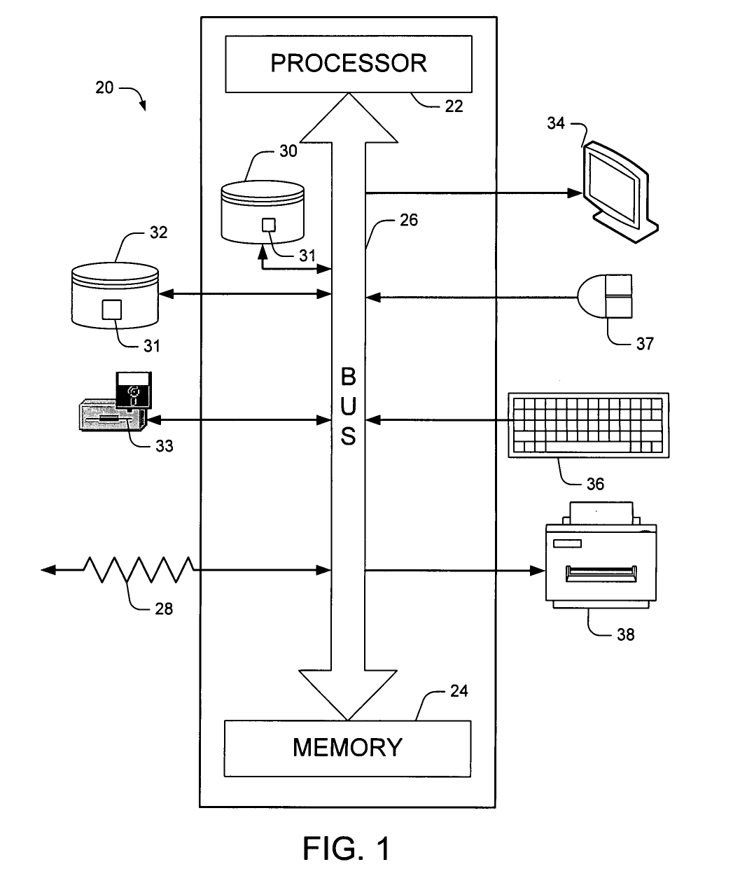

FIG. 1 is a block diagram illustrating a General Purpose Computer 20. The General Purpose Computer 20 has a Computer Processor 22 (CPU), and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such test programs, operating systems, and user programs can be stored in a Computer Software Storage Medium, such as memory 24, Secondary Storage 30, and External Storage 32. Executable versions of computer software 33, such as defragmentation software and operating systems can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

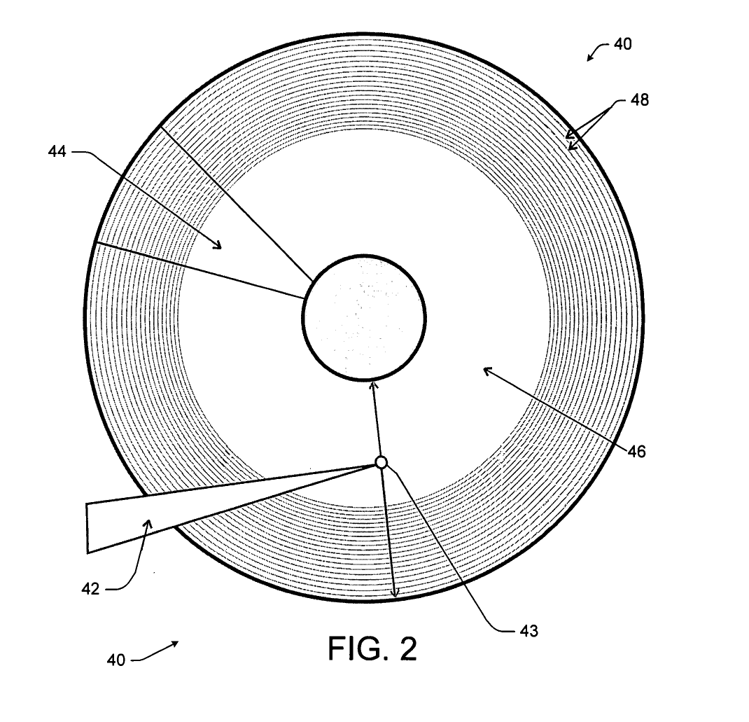

FIG. 2 is a diagram of an exemplary hard drive, in accordance with the prior art. A hard drive 40 typically consists of one or more circular platters 46 of magnetic media, wherein the magnetic media can be recorded on one or more surfaces. A typical hard drive platter 46 typically consists of a plurality of circular concentric tracks, each of which contains a large number of recordable and readable data bits. A read/write head 43 is moved back and forth with an arm 42 over the surface of the platters 46, capable of reading and/or writing one track as the disk spins at a high rate of speed beneath the head 43. Moving the arm, and thus the heads, changes the track to be read and/or written in an action termed a “seek”. The area that is swept during a specific period of time is termed a “sector” 44. In the case of multiple surfaces and platters, the arms 42 and 43 for reading such typically move together, forming a cylinder of tracks 48. The data on the various tracks of a cylinder are thus typically accessed together and are often considered a single logical unit. Also, note that some arms 42 contain separate read/write heads 43, and some hard drives contain multiple arms and heads, which may or may not move together. All such configurations are within the scope of the present invention.

A user's hard drive is typically the only “data handling” peripheral in his computer with moving parts. This typically makes it the slowest performing peripheral, especially when compared to the processor 22 and memory 24. As a result, it is often the performance rate limiting device on his computer 20. Most of the time, the processor 22 and memory 24 have done their work and are waiting on the hard drive 40 to provide or save data.

In the most simplistic of descriptions, a hard drive consists of spinning platters 46 and read/write heads 43. The platters 46 contain data bits that consist of magnetic patterns of data. The platters 46 currently typically spin at a rate currently of anywhere between 4,200 and 15,000 RPM, depending upon drive specifications. This rapid rotation of the platters 46 results in a cushion of air that makes the read/write heads float only a few micrometers above the surface of the platters—just like a hovercraft floats a few inches above the water. When a request for a file is sent from the main CPU, the read/write heads 43 move across the drive to locate the file, they then read that file and send the data back to the CPU.

Currently, under the most recent Microsoft Windows operating systems, a file may be 512 bytes in size or it may be many Gigabytes in size.

If users do not run any kind of defragging or file ordering process, generally speaking, files exist on their disk drives in seemingly random order. Files may also become fragmented through usage and this is typically a leading cause of reduced hard drive performance.

Fragmentation of users' computer's hard drive is a natural phenomenon that occurs when deleted files leave empty spaces amongst their drive's data. When the operating system needs to write another file back to the hard drive, it generally looks for the first available free space and writes the data to that free space. If the data to be written does not fit in that space it will fill the space with data and then move onto the next free space and continue to write the data until the file is completely written—the result is often parts of a file scattered in a fragmented (non-contiguous) manner.

When the operating system requests that fragmented file from the hard drive, the hard drive read-write heads typically need to move around the drive to collect all the pieces of that file. The result is often vastly reduced performance since the hard drive head has to make many movements to collect all the pieces of the file rather than pick it all up in one smooth motion from consecutive clusters.

The more fragments a file has, the longer it takes to load that particular file. The result is that a user's hard drive performs far slower than it is capable of in the process of loading that file. This is, in a nutshell, the phenomenon of file fragmentation.

File fragmentation is typically only part of the equation in the cause of reduced hard drive performance. The present invention addresses this and the other, possibly more important, part of the equation in reduced hard drive performance and that is, the placement and ordering of files on a user's hard drive.

Most defraggers that are currently on the market have mostly ignored this often much more important aspect of hard drive performance—the placement of files on a hard drive. Loading one file that is fragmented is a discreet issue at the individual file level. However, the way in which the Windows operating system and NTFS file system function results in an almost constant dialog between the computer and the hard drive as hundreds of files are accessed during system boot time and during regular operation of the computer.

What comes into importance here is the work the hard drive read-write heads need to do to read all of these files that are both fragmented and scattered all around the drive. If they are not fragmented they are still scattered all around the drive and loading these files requires extensive movement of the hard drive read-write heads to pick up these files from wherever they may be on the drive—from the outer tracks to the inner tracks. Reading a file from the outer tracks and then having to go all the way to the very inner tracks takes the amount of time that is actually twice as slow as a drive's rated seek speed. If a hard drive has an average access speed of 13 mS, then reading a cluster from the outer and then the inner track typically takes on average about 26 mS.

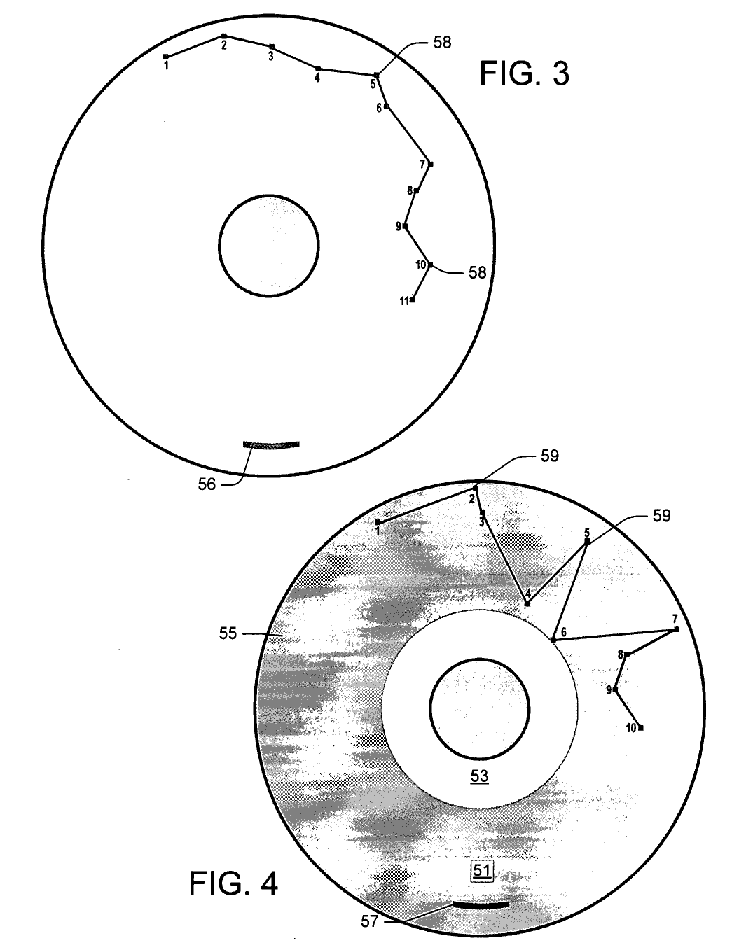

FIG. 3 is a diagram illustrating an exemplary fragmented file 58 and a contiguous file 56 located on a hard drive. The fragmented file 58 consists of a plurality of file fragments logically connected together to form a single file. In the example shown, the file consists of 11 segments, each numbered, and shown with the lines that logically connect them. The contiguous file 56 contains all of its data in a single location. The result is that it will typically take a single seek to access the data of the contiguous file, but in this case, likely 11 seeks to fully access the data in the fragmented file 58.

FIG. 4 is a diagram illustrating an exemplary fragmented file 59 and a contiguous file 57 located on a hard drive. The fragmented file 59 here consists of ten physical blocks, logically connected together by the operating system. The difference between this FIG. and FIG. 3 is that here, the cause of the fragmentation is that the hard drive is nearly full. The outer portion of the hard drive is filed with files 55, and the inner portion is empty 53. This is, of course, illustrative only. It is significant though that one of the primary reasons for an operating system fragmenting files is that the hard drive is full enough that the operating system cannot easily find a contiguous region in which to store a new file. Another reason for fragmented files is that some files change size through time, and some operating systems address file growth by “tacking on” more disk space.

Another important item to note is the location of the data on a hard drive. Currently it is a typically true that data transfer from the outer tracks of a hard drive platter is about 180 to 240% that of the inner tracks. This is due to the phenomenon of zoned bit recording and angular velocity. Referring back to FIG. 2, note that the area 44 swept out by an arm 42 forms a pie shape 44 over a specified period of time. This means that if data is recorded at a constant density around the various tracks and cylinders 48 of a disk, the tracks further out from the center contain more data within such a pie shaped area than do the tracks and cylinders closer to the center.

A hard drive is currently typically capable of performing approximately four (4) times what manufacturers specify as the average performance for their hard drive. This is part of what the present invention strives to achieve. In order to have a hard drive perform as fast as it is capable of, and even faster than the average rated speed, four elements should preferably be considered:

1. Files should be defragmented in order to minimize drive head movement while reading a file.
2. Files should be placed as far as possible towards the outer tracks of your hard drive in order to be accessed from the fastest part of the hard drive.
3. Files should be placed or consolidated as closely together as possible to minimize head movement while loading different files—also known as “seek confinement”; and
4. Files that are rarely used should be placed out of the way so that the most used files are clustered as closely together as possible.

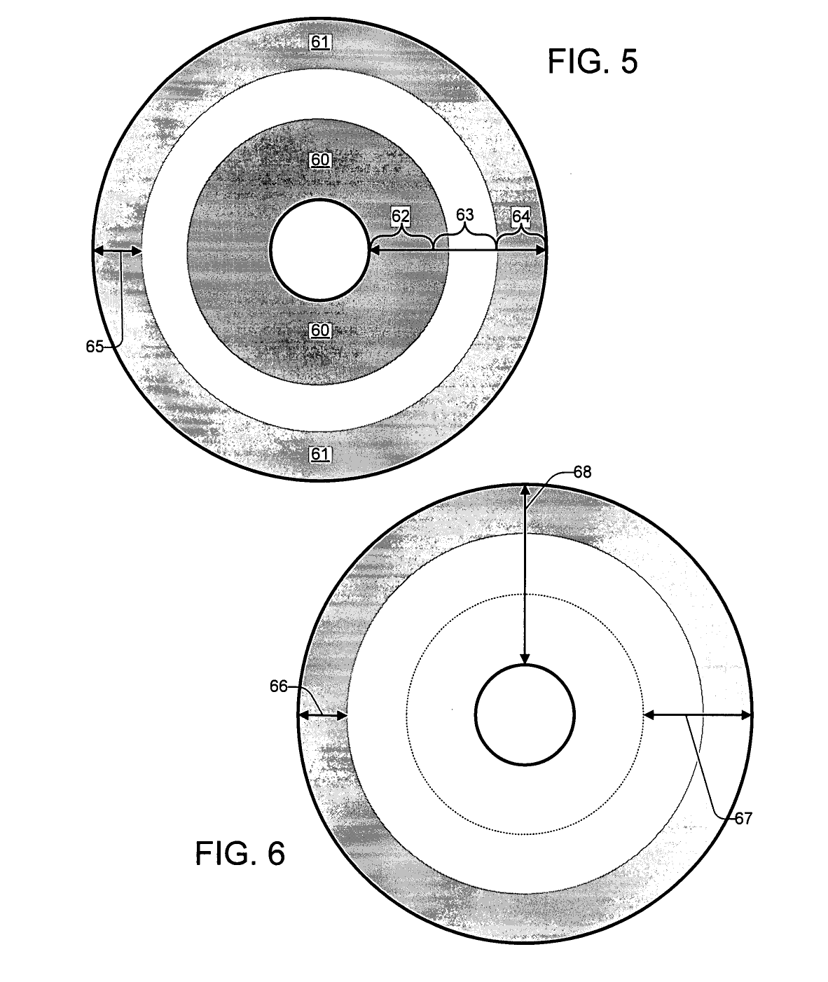

FIG. 5 is a diagram illustrating exemplary ideal file placement on a hard drive. Disk access time is graded from the inside out, from slow 62, through average 63, to fastest 64. Frequently stored data is stored on the fast outer tracks 60, and rarely used data is stored on the slow inner tracks 61. The outer tracks provide excellent seek confinement 65.

FIG. 6 is a diagram that illustrates disk seeking. Seek confinement 66 is the situation where the disk arm does not typically need to move outside a small zone in order to satisfy most disk requests. A full stroke seek 68 is when the arm has to move the entire distance, either from the outside to the inside of the disk, or visa versa. This is the worst case scenario for any disk access. And an average seek 67 is when an arm moves an average distance in order to satisfy a disk request.

The present invention achieves all this with the end result being hard drive performance that is often currently around 300 to 400% that of a drive's current manufacturer rated performance. Since hard drives and the Windows OS already have built in performance enhancing measures, the performance increases a user will see from the present invention will currently often be anywhere between 30% and 100%.

This disclosure will now focus a little more closely on how a hard drive works from the viewpoint of data access. This will help illustrate the way that the present invention significantly improves a drive's performance.

Some Important Terms:

Seek Time: The amount of time a drive head takes to move to the correct position to access data. Usually measured in milliseconds (mS)

Latency: Also know as rotational delay. The amount of time it takes for the desired data to rotate under the disk heads. Usually the amount of time it takes for the drive to perform a half revolution. Usually measured in milliseconds (mS)

Access Time: The amount of time a drive head takes to access data after the request has been made by the operating system. Usually measured in milliseconds (mS). Other minor factors taken out of the equation it is very closely approximate to:

Access Time=Seek Time+Latency.

So when data is being requested from the drive the hard drive head moves into position (seek), waits for the data/sector to move into position under the head (latency) and then accesses the data. The time taken for these 2 steps is the access time.

Full Stroke Seek: The amount of time it takes for the drive head to move from the outermost track to the inner most track.

Track-To-Track Seek (Adjacent Track Seek): The amount of time it takes for the drive head to move from one track to the very next track

Data Transfer Rate: The speed at which data can be read from the hard drive. Measured in Megabits per second

Zoned-Bit Recording: A method of optimizing a hard drive (at the factory) by placing more sectors in the outer tracks of a hard drive than on the inner tracks. Standard practice for all modern hard drives.

Sectors: The smallest individually addressable unit of data stored on a hard drive. In a typical formatted NTFS hard drive it is usually 512 bytes.

Tracks: Tightly packed concentric circles (like the annual rings on inside of a tree) where sectors are actually laid out.

Rotational Speed: The speed at which a drive platter rotates in revolutions per minute.

With all these terms now outlined, let's look at the numbers in a currently typical 160 Gb EIDE hard drive:

| | | |
|---|---|---|
| Read Seek Time: | 8.9 | mS |
| Latency | 4.2 | mS |
| Full Stroke Seek: | 21.0 | mS |
| Track-To-Track Seek: | 2.0 | mS |
| Transfer Rate: | 750 | Mbits/s |

Hard Drive Performance Explained

Data Access. When the CPU submits a request for a file from the hard drive—this is what currently typically happens:

1. A CPU sends a request to the hard drive.
2. The hard drive's read/write head (or heads) moves into position above the track where the data is. This is the seek and the amount of time taken is the seek time.
3. The read/write head waits until the data that is requested spins underneath the head. It then reads the data. The time taken for the data to move beneath the head is the latency and is usually the time it takes for the platter to rotate a half revolution.
4. Data is accessed and transferred back to the CPU.

The time it took for the initial request, the seek and the latency is currently typically approximately equal to the access time.

Having the numbers above available now enable further explanations of data performance to be put into comprehendible perspective.

The average Access Time for this hard drive is 8.9+4.2=13.1 mS. The minimum access time is 2.0+4.2=6.2 mS and the maximum access time is 21.0+4.2=25.2 mS.

When complete data files or parts of a data file are scattered all around the hard drive, a user will get a performance that is the average rated access time—in this case 13.1 mS—some accesses are as little as 6.2 mS but some are as great as (or approaching) 25.2 mS. So there is a 406% performance difference between fastest and slowest access time.

Often, hard drive and operating system intelligence result in a lot of instantaneous track-to-track seeks i.e. without the latency due to file layout patterns and relative location of data. On top of this, the “seek confinement” of the data also promotes vastly increased probabilities of instantaneous, zero-latency, seeks due to the “compaction” of the data. This increases the probability that the data requested will already be under the drive read/write heads. This actually increases the theoretical 406% figure in the above paragraph to a greater number, however it is not currently accurately quantifiable, but can be as high as 1000%.

In a typical fragmented and non-optimized hard drive a user will typically only achieve the average rated performance as average access time with some accesses faster and some slower.

Part of the hard drive performance equation is Data Transfer Rates. Due to a combination of Zoned-Bit Recording (more densely packed sectors) and angular velocity i.e. the outer tracks of the hard drive have a greater angular velocity—data transfer at the outer tracks of the drive currently is typically 180 to 240% that of the inner tracks. So when a drive is boasting a maximum of 750 Mbits/second as the maximum—the minimum is about 350 Mbits/second and the average about 550 Megabits per second. Again—if a user is operating a full, fragmented and non-optimized hard drive, performance is typically more around the average of 550 Megabits per second.

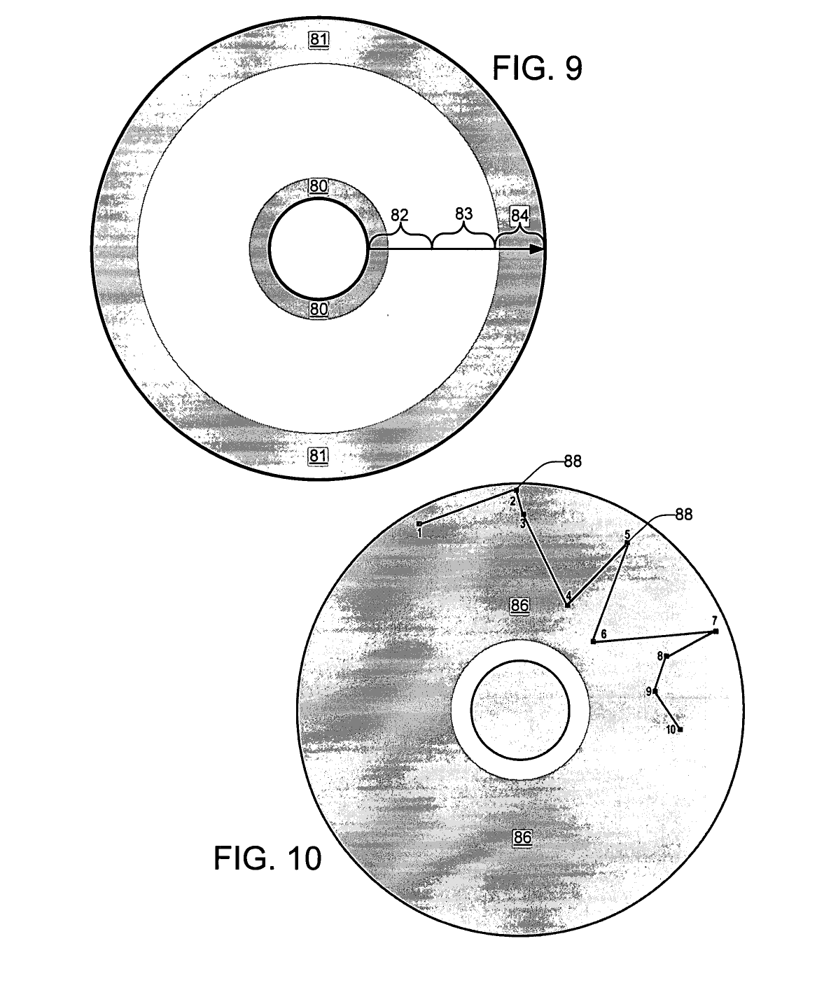

FIG. 9 is an exemplary diagram illustrating hard drive transfer performance. The outer tracks 81 have the fastest 84, the intermediate tracks have an intermediate transfer rate 83, and the innermost tracks 80 have the slowest transfer rates 82.

When it comes to hard drives, entropy is alive and well. If a user has had a computer for a while, he may notice that, when compared to when it was brand new, it feels a whole lot slower. Also, as a hard drive gets fuller users often notice the same phenomenon.

FIG. 10 is an exemplary diagram that illustrates hard drive fatigue. As a hard drive fills up 86, newly created files 88 tend to be more fragmented and spread over numerous tracks throughout the disk.

This is due to several factors with the main one being that with the hard drive filling up and files being fragmented and scattered all over the drive in no particular order, a drive is performing more like the “average” quoted performance as opposed to when the drive was new and mostly empty and performing better than quoted. Depending upon where the mostly accessed files are located, it could be performing much less than quoted averages.

Please refer to the ideal scenario discussed above. There are typically four main factors that contribute to reduced hard drive performance and subsequently typically four main factors that can be addressed to improve hard drive performance. These incremental improvements all compound each other so the result is greater than the sum of parts. The improvement is not just an improvement to average performance, instead it can sometimes be improved by up to 300 to 400% of a drive's quoted average performance!

Most current defraggers only deal with “fragmented” files—they quote performance improvements by up to 100%. But all they are referring to is the performance of accessing those fragmented files, which a user may only rarely access anyway. These programs might add only milliseconds of performance improvement. No consideration is typically taken into placement of files and other items that need to be considered to improve the performance of your drive. As a result, a “defragger” program typically only brings a hard drive and its fragmented files back up to average quoted performance.

This is one place where the present invention provides a significant benefit to users. The present invention brings a hard drive up to performance that sometimes exceeds average drive manufacturer quoted performance by around 300 to 400%. Since there are already performance enhancing systems in hard drive logic and Windows O/S, a user may experience performance increases anywhere between 30 and 100%.

Pareto's Rule—The 80/20 rule. Pareto's rule pervades our world. 80% of the wealth is distributed amongst 20% of the population. 20% of a company's customers contribute to 80% of its revenue. Pareto's rule also typically applies to PC file access. 80% of the time a user only accesses 20% of his files. You can typically extrapolate that to 90% of the time the user only access 10% of his files.

If you apply Pareto's Rule to 100 Gb of data, generally speaking, 80% of the time a user only access about 20% of that data, so the present invention:

1. Places the least accessed data out of the way of the high performing areas of a drive and moves it to the slowest part; and
2. Gets the data that a user accesses the most and place it to where it gets the best performance.

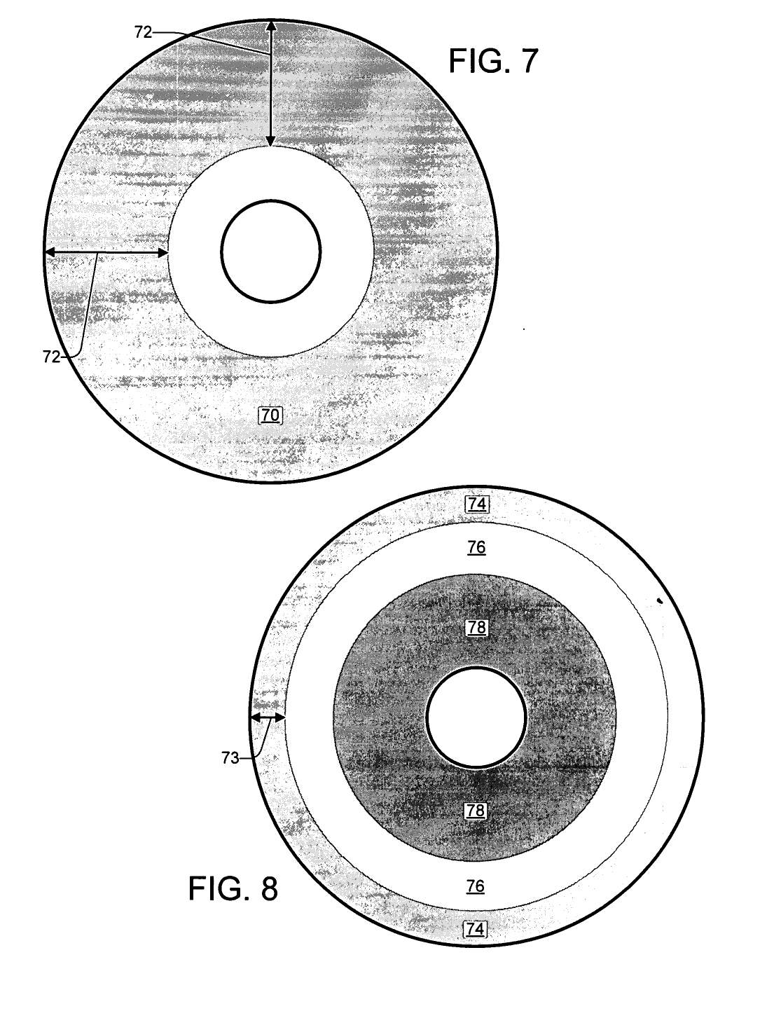

FIGS. 7 and 8 together illustrate the application of Pareto's rule to optimizing the placement of files on disk drives. FIG. 7 is a diagram that shows a typically hard drive that has not been optimized. Since the files are effectively randomly placed on the hard drive, the seek confinement 72 is typically poor, especially in this illustration since the disk is mostly full 70.

FIG. 8 is a diagram that illustrates the results of optimizing file placement on a disk drive utilizing Pareto's rule, in accordance with the current implementation of the present invention. As such, it is similar to the ideal hard disk scenario shown above. Frequently used files are stored to the outside of the hard drive 74, rarely used files stored to the inside of the hard drive 78, with the center open for expansion 76. This results in excellent seek confinement 73 to the outer band 74 of frequently used files.

These two very important aspects of file placement are part of what the present invention addresses—and it gives a user almost no limit of power as to what he can do as far as manipulating what goes where on his hard drive—right down to the individual file level. This is why the present invention is a revolutionary defragmentation and disk optimization product.

One question that many people have asked is that in the pre-NTFS days there was risk to defragging. If there were a power outage in the midst of a defrag—a user could have lost important data. That has all significantly changed now with the introduction of the Microsoft NT File System (NTFS), and defragging with NTFS is typically currently 100% safe. The actual defragging APIs used are typically the APIs created by Microsoft themselves for NTFS and many, if not most, defraggers currently on the market use these API's. In general with these API's—data is not erased from its original location until it is verified as being correctly written. A product such as the present invention uses those API's to place files where it wants them to go.

Partitioning is a method of dividing a hard drive into smaller logical disks. It became popular awhile back when earlier versions of Windows could not address an entire hard drive. Even today, there are many arguments for partitioning. Proponents of partitioning often argue that it helps organize their data, keep their hard drive “less” complex etc. They advise users to put their operating system on one partition, archive on another, program files on another, data on another and to some, it seems a sound argument.

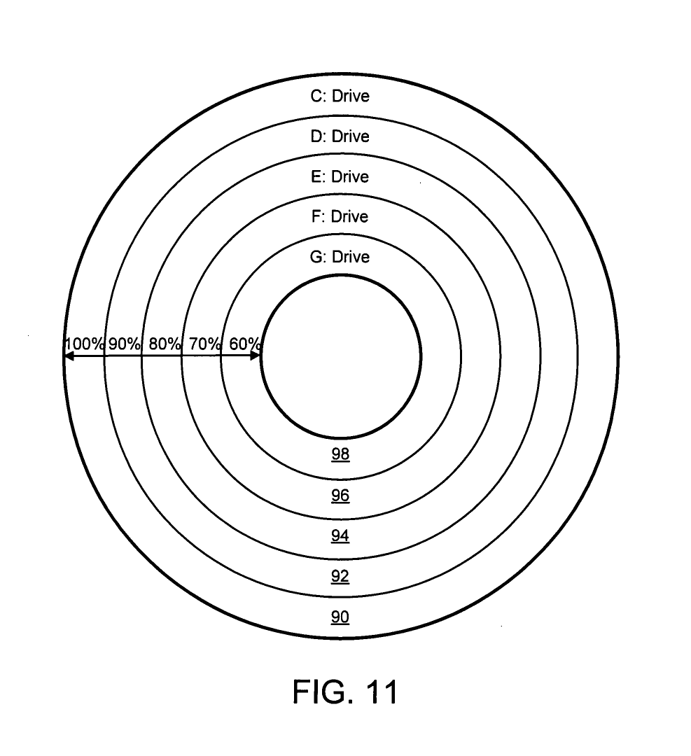

FIG. 11 is an exemplary diagram illustrating hard disk partitioning. This disk is partitioned into five partitions, C: 90 drive to the outside, then D: 92, E: 94, F: 96, and G: 98 on the inside, with each partition being seen as a contiguous grouping of tracks/cylinders. Transfer rates range from 100% for the outer, C: 90 drive, down through 90% for D: 92, 80% for E: 94, 70% for F: 96, and 60% for G: 98. Note that these transfer rates are illustrative only and portray the average transfer rate for those disk partitions. Also, other operating systems use other methods of partitioning, but many, if not most, share the important features of this example, and are within the scope of the present invention.

One current major problem with partitioning however is that it actually creates logical drives that typically are slower and slower as more partitions are created. Partitions are currently created by Windows in cylinders (group of tracks) working their way inwards as more are created. So a user may create, for example, 5 partitions of 40 Gb on a 200 Gb drive. The very inner partition—the highest drive letter is actually also created at the inner tracks. So it actually typically performs twice as slow (or half as fast) as the primary partition. Remember the discussion of data transfer above. Each partition is about 10% slower than the previous one. C: drive 90 gives the fastest performance; D: 92 would be approximately 10% slower; E: 94 approximately 20% slower; F: 96 approximately 30% slower; etc. A user may be putting the games or product that he wants highest performance from on a partition that results in much slower performance of that product.

The present invention typically eliminates any requirement for partitioning for the purpose of data organization and typically dispels any requirement for partitioning from a performance point of view.

The present invention lets a user take the hotchpotch of files that are on their system—put the least used and unused files to the inner tracks and keep the most often used files to the outer tracks where the user may require performance regardless of which files they may be. It is almost like partitioning on the fly without the “mental” decisions of needing to constantly think about what goes to which drive when users are saving data and installing programs. Simply do it all on the one physical drive. Partitioning overhead is eliminated. Use folders for what they were intended for and then use the present invention to keep what the users need where they need it on their drive. No partitioning is typically required! However, also note that since the tracks in a given partition have similar characteristics to tracks within a hard drive, the present invention may also be used effectively on partitions in a partitioned disk drive.

The present invention is very simple to use yet very powerful in its defragging and file placement options.

Even though it also covers file placement and relocation (as well as defragging), hereinafter each option will be referred to as a “Defragging Method”. With the present invention there is a Defragging Method for virtually every current envisioned computer or hard drive application—from gaming machines to servers, from empty drives to full drives.

The present invention lets a user customize his hard drive layout right down to where individual files are placed on his hard drive relative to the other files.

If a user has a specific game or application that he wants best performance from—he can move its files to the very outer tracks (“hot spots”) of his drive. If he wants all of his programs to load as fast as possible when he executes them—he can put all of their EXEs and DLLs to the outer tracks. If he wants Windows to boot as fast as possible, he can put all of the Windows boot files to the outer tracks. If he wants best performance from his digitized photo album browsing—he can put all these to the outer tracks.

Conversely, if a user has compressed Zip files of archived data that he rarely, if ever uses, he can put them to the inner tracks where performance is slowest since he will rarely, if ever need them. All those Windows update files that never get used again, he can also put them to the inner tracks and out of the way. Windows actually only uses about 20% of the files in the Windows folder—the ones that are not used can be placed right out of the way and to the slower performing inner tracks since Windows almost never uses them. In the present invention, putting these files to the inner tracks is termed “archiving”.

A user can choose individual files or file types for both high performance and archiving or he can let the present invention do it automatically based on the last usage of those files.

The Present Invention Mind Set Goals

Referring back to the Ideal Scenario diagram shown in FIG. 5. When a user is using the present invention—the mind set that he preferably should have when performing his Defrag Scenarios is to aim towards:

### 1. Defragging Files

2. Getting his rarely used data out of the way—ZIP files, unused system files, etc.
3. Getting his most often used data to

i. The outer tracks

ii. In some form of logical sequence

iii. As close together and compacted as possible to improve “seek confinement”

### 4. Maintaining Optimum Performance

5. Making subsequent defrags as brief and as fast as possible.

Option 3 in this list is often currently the most critical in getting the performance increases utilizing the present invention. A user is placing his most used (and most likely to use) files to the outer tracks. At the outer tracks the transfer performance is typically double that of the inner tracks and 150% of the average one would normally achieve with a non-optimized drive.

Also a user would have compacted his most used files to only spread over a smaller percentage of his hard drive area—so he is typically confining most of the disk seeks to being adjacent track seeks of currently typically 1 to 2 mS and probably no more than 3 or so mS. He is also promoting instantaneous seeks where expected requested data is typically already there under the heads of a disk drive thus often completely eliminating latency in a vast percentage of his hard drive data accesses.

The main graphical user interface (GUI) is where it all happens. Almost everything a user needs to operate the present invention is just a mouse-click away.

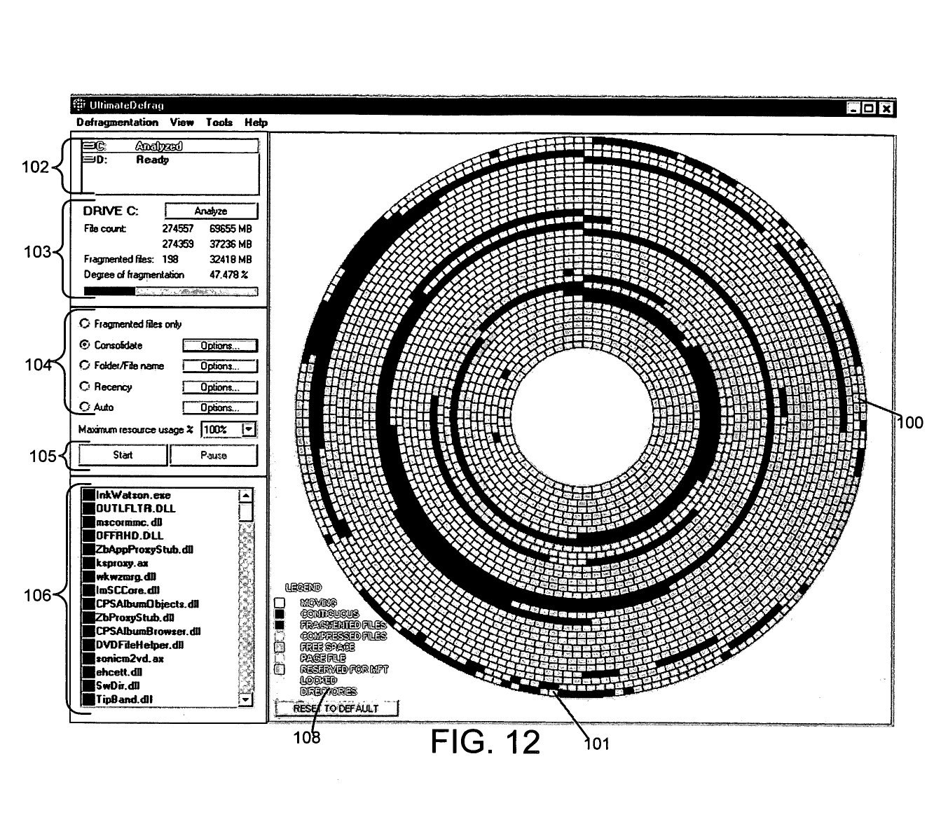

FIG. 12 is a diagram illustrating the main graphical interface of the current implementation of the present invention. A disk or disk portion is selected in a disk selection window 102. As a result, a “true disk” metaphor 100 for the selected disk or partition is displayed showing clusters or groups of clusters organized in concentric circles of ever larger diameters radiating out from the center. The clusters or groups thereof represent disk space for files located in that area. Clicking on one of the clusters displays the contents of that cluster in a cluster analysis box 106 located in the lower left of the GUI screen. This cluster analysis box 106 contains a list of the files or file parts located in the selected cluster, and when one of them is selected, the specific properties of that file are displayed.

The clusters in the true disk metaphor display 100 are colored according to a legend 108 located just to the lower left of the true disk metaphor display 100. The current default color assignments are:

| Color | Description |
|---|---|
| Orange | Moving |
| Dark Blue | Contiguous |
| Red | Fragmented Files |
| Aqua | Compressed Files |
| White | Free Space |
| Dark Green | Page File |
| Yellow | Reserved for MFT |
| Gray | Locked |
| Green | Directories |

The color assignments can be customized, or later reset back to their defaults. Hereinafter in this discussion, it will be assumed that the default colors are in effect. Also, since the blocks in the display typically often include segments from multiple files, the actual colors displayed in this implementation are a blend of the colors assigned to each file or file part in the block. The same colors are used for each file in the block in the Cluster Analysis box 106 for the currently selected block, except that these colors are typically not blended, since they apply to a single file, and not a plurality thereof.

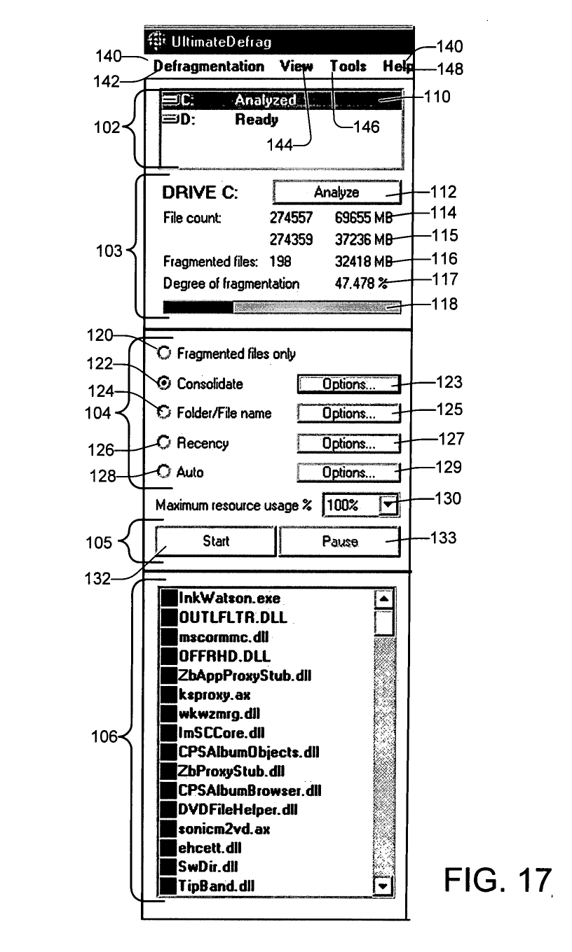

The GUI interface has a set of controls down the left side of the screen, to the left of the True Disk metaphor display 100. As noted above, a disk selection box 102 is at the top of these displays. This is followed by disk information 103 for the disk or partition selected. Below this is a defrag method selection 104, followed by Start and Pause buttons 105. And below these buttons is the cluster analysis box 106. These controls are disclosed in more detail in FIG. 17 below. As with most windows applications, there is a menu control bar across the top, containing: “Defragmentation”; “View”; “Tools”; and “Help” menus.

In the current implementation of the present invention, under the Tools option on the top menu bar is an Options selection. This is where much of the power of the present invention is since this is where a user selects his high performance and archiving options. This will be discussed below.

The Disk Display. The first thing that some notice with the present invention when they first load the current program implementing the present invention is a unique “true disk” metaphor 100. This true disk metaphor 100 helps a user to more accurately see what is happening with his disk drive—where his files are located and where they are not. It also gives him a very good look at the location of his metafiles such as the MFT and Paging File. There is a legend 108 at the bottom left of the screen that shows a user the colors corresponding to the different file categories that the disk is displaying.

When a user first loads the current program implementing the present invention, the program will default to the C Drive being selected in the disk selection box 102. If the disk is partitioned or other disk drives are present, they can be selected instead. Most of the file space is initially shown as undefined. This is a brief snapshot of the disk usage bitmap. When the user clicks on the Analyze button 112, this implementation of the present invention will analyze the selected disk drive and the user will see the colors of the blocks change according to their use.

This representation of the disk being analyzed is divided up into rectangular blocks. The blocks are arranged in concentric circles around the center of the disk in the true disk metaphor display. Each block represents of a group of clusters. Clicking on a block displays the filenames and a color from the legend that are in the group of clusters on the bottom left hand side of the display under Cluster Analysis 106. Clicking on a filename in the Cluster Analysis box 106 shows the full path of the file, the cluster positions of the file, and also the number of fragments the file has. If the file is contiguous it will display the word “contiguous”. Using up or down arrows when someone has selected a file will display information on the next highlighted file.

The present implementation has a very fast drive Analysis feature that can be invoked. On a typical disk drive with 50,000 to 100,000 files, the current implementation will typically analyze the drive in around 20 seconds. The more files on a disk drive, the longer it will take to analyze. In this implementation, Analysis will display the file count and space occupied by these files and will then also breakdown into contiguous files and space and fragmented files and space.

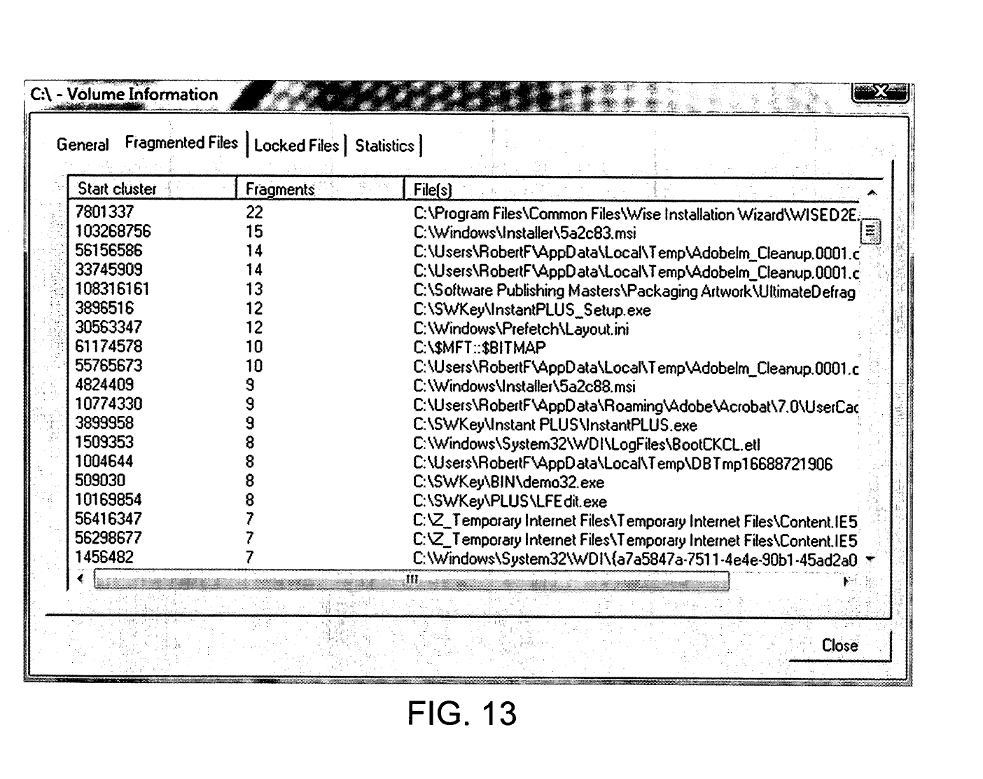

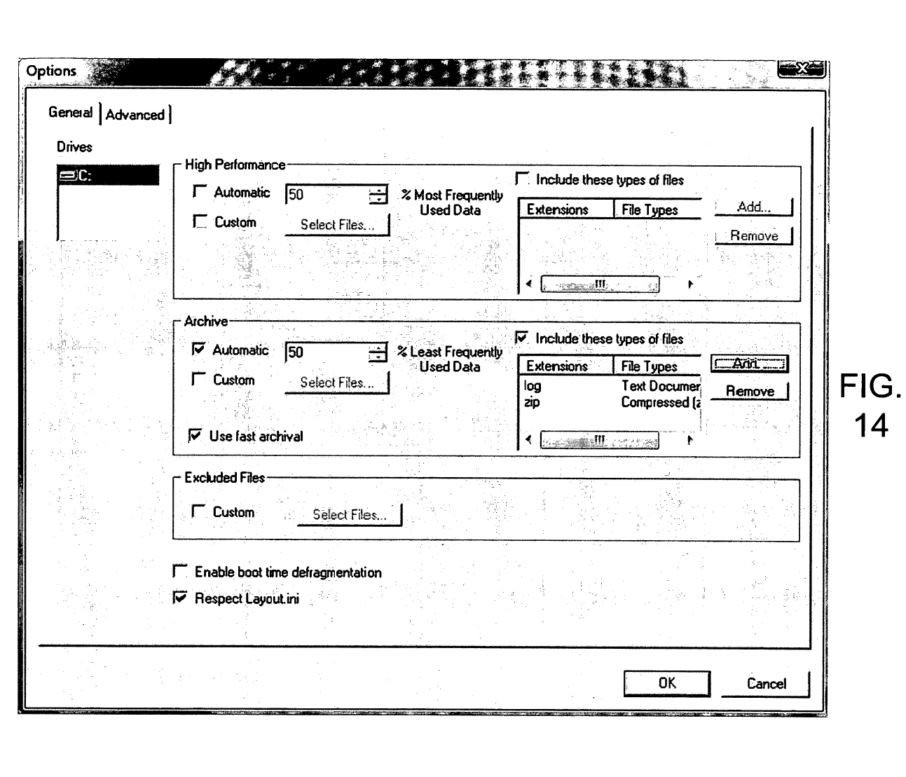

FIG. 13 is a diagram showing Volume Information, in accordance with the current implementation of the present invention. It is also possible in this implementations to find a list of which files are fragmented and how many fragments they have by first clicking on the drive letter in the disk selection box 102, followed by selecting the Volume Information, and from that, selecting the Fragmented Files tab. The list of fragmented files can be sorted by clicking on the top of the column containing the primary sort key. By using this feature this way a user can get a quick look at which are his most and least fragmented files. Contiguous files are not displayed in this list. The General Tab will show you basic information on a drive including File System, Cluster Size and other information.

File Menu/Tools/Options. FIG. 14 is a diagram that shows an Options screen that can be activated from the File Menu via the Tools submenu shown in FIG. 12. The Options screen shown in this FIG. is the initial, “General” options screen. A second “Advanced” options screen can be selected via a tab. This Options screen is the section where a user can set critical high performance and archiving options. While elegantly simple, it is extremely powerful with the user being able to select which files he requires high performance from, which files are to be archived, and which files are excluded. Some important terms to understand in using the Options screen:

High Performance Files are moved to the outer tracks (hot spots) in the order they are selected;

Archive files are moved to the inner tracks—these files are files that a user would consider not used or rarely used and can be moved to the slower inner tracks and out of the way.

Excluded Files are ignored by the defrag process. These can be whatever files the user wants. They are left in their place unmoved when the defragmentation is performed.

It is also possible in this implementation to change options for a drive. In order to do that, the user would first highlight the selected device. He could then select the option that he wished to set for that particular drive. Note that in this implementation, any parameters specified under High Performance or Archive are ignored unless the “Respect High Performance” or “Respect Archive” is selected when the user performs an actual defrag.

It is possible to select “High Performance Files”. This option is very powerful and this is where a user can achieve the high levels of performance outlined above. High Performance files are moved to the very outer tracks of the drive—this is where data transfer rates are the highest—currently typically about double that of the inner tracks. Also putting these files closer together towards the outer tracks provides for “seek confinement”, thus reducing seek and access times—often significantly.

If a user uses his computer for general computing use, he may want to simply automatically put all files that he normally uses on a day to day basis to the very outer tracks of the drive. He can specific what percentage of his most frequently used files he wants under the Automatic option. The term % Most Frequently Used Data relates to the frequency of use relative to other files. So if a user wants to automatically place the 20% most used files to the outer tracks then he can simply select 20%.

If a user wants to make all programs load as fast as possible regardless of when he last used them then, under “Include files of this type” the user can simply select Add and add files with extension .EXE—he can also add .DLL or whatever file-type he wants performance from regardless of when he last used it. Selecting 10% and adding .EXE to the Include option will place his 10% most used files and all .EXE files to the outer tracks of the disk. He can also add .DLL files since these are used a lot in launching and operation of most programs. When he adds file types to this list, he can then drag and sort the file types by clicking and dragging each line item in the order he wishes to have them laid out.

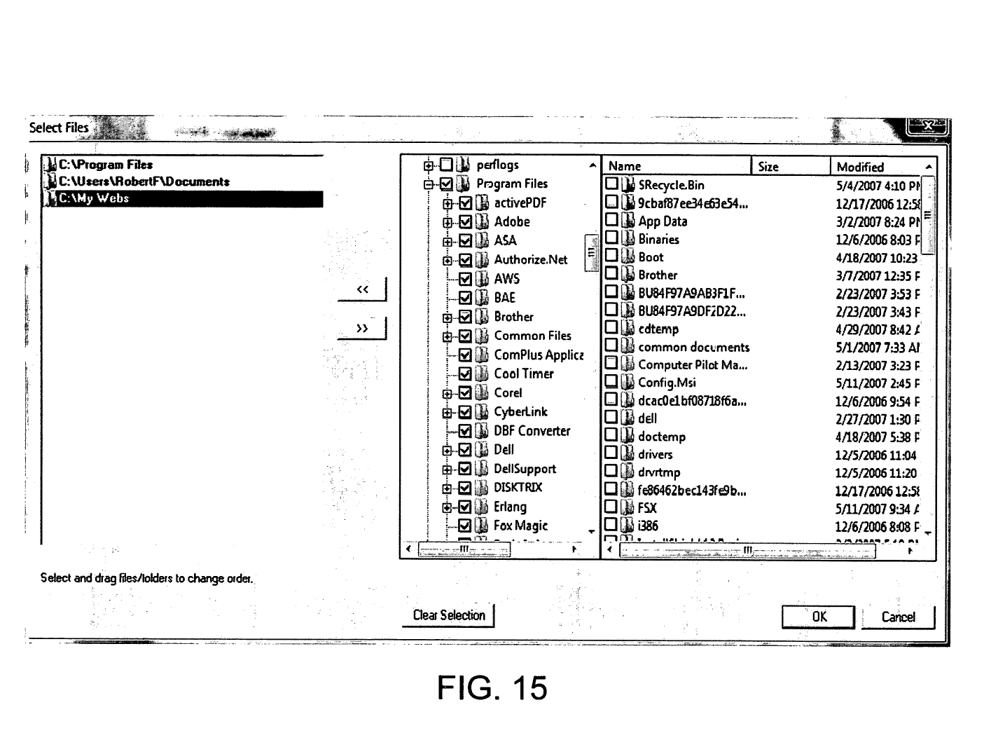

FIG. 15 is a diagram showing an exemplary file selection page used to select High Performance files, in accordance with the current implementation of the present invention. If a user wants much more customization, he can click on the Custom option and a file selection page appears. He can then select folders and even individual files, and then he can even specify the order of these files and folders. To select a folder or file, the user simply selects the folder and/or file names, and then adds them to the High Performance list. If he wishes to change the order of the folders or files in the High Performance list, he can simply select the file or folder on the left hand column and drag it up and down to the position you want it. The folders and the files within them will then be placed in that exact order when the disk is being defragged. In the situation where a user may have a particular game that he wants to achieve highest performance for, he can help achieve that by dragging that game to the top of the list, or if he wants fastest boot performance with general Windows and user Program performance, he can put the Windows directory to the top of the list and Program Files below it. If a user does not wish to specify any files for High Performance, this can be accomplished by simply select None.

If there are files that a user is simply not using, or not using very often, the “Archive” option can be useful for getting these files out of the way and moving them to the slowest part of the disk since they are rarely required (if at all). This option can be as powerful and as flexible as the High Performance option. Files that may fall into this category are ZIP files, or folders with collections of pictures that the user doesn't ever view. He may want to put other least used files into the Archive area. Remember the 80/20 rule—80% of the time a user only uses 20% of the files, so here he can put his 80% least used files into the archive area. If a files does get used, then in the next defrag it will be moved out of the Archive area. Selecting files/folders, file types, and/or frequency of use works just like the High Performance option, only in reverse, with the selected files moved into the inner tracks.

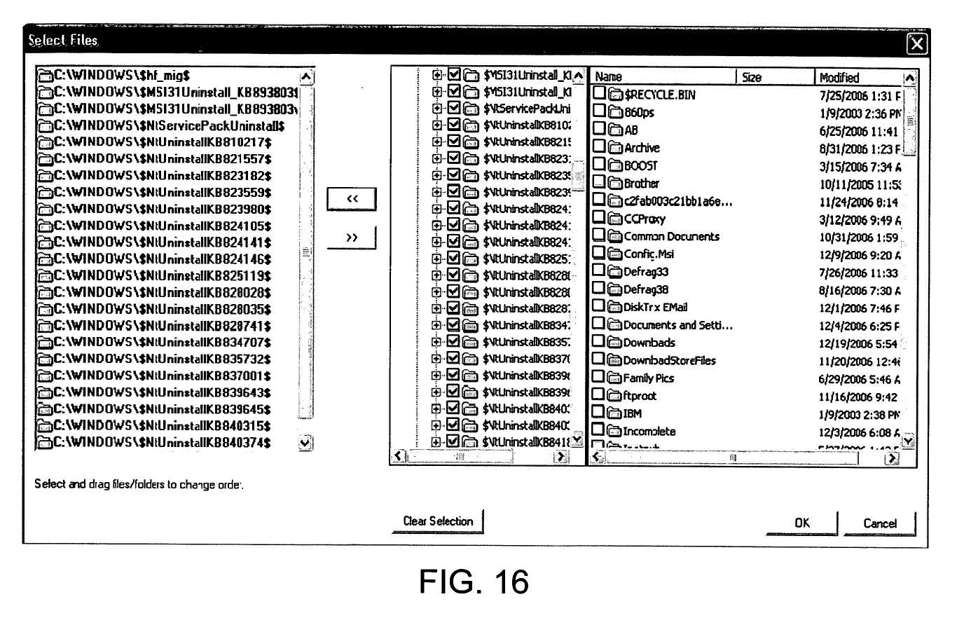

FIG. 16 is a diagram showing an exemplary file selection page used to select Archive files, in accordance with the current implementation of the present invention. In the case of the Archive option, a user may want to archive some of those extraneous Windows update files that will presumably never be used again. If someone were to look in his Windows directory, he would often see about 70 folders beginning with “$”. These are updates that will almost never be required again. The Archive option moves them out of the way. This FIG. shows selection of these Windows update files.

In Archive mode, if a user selects % Least Used, files are sorted from the least used file to the very last clusters, and then the present implementation works its way outwards. Currently, this can sometimes take some time to perform, and that's why it has a powerful “Fast Archive” option.

Fast Archive. The Fast Archive option speeds up the archive process. It partially does this by not completely resorting the Archive files. Instead, this option or mode looks at each file, and if it belongs in the Archive section based on a user's Archive criteria, it puts it there. If the file is already there, it is ignored. If it does not belong as specified by the Defrag method or High Performance option, then it is moved out.

In the current implementation, on a typical user system, this can make archiving take only minutes on subsequent defrags, instead of potentially hours. Fast Archive mode may leave small gaps in the user's consolidated data in his Archive file section. This is part of the trade-off for typically much faster archiving. It should not affect or promote re-fragmentation. Using this option, a relatively full disk drive containing a lot of data can take very little time to be brought back to near optimum performance because archived files are only moved if they need to be.

Excluded Files. A user may want to leave certain files or folders completely untouched and ignored by the defrag process. For example, he may have a folder with 20 Gb of data comprising of very large files. He never uses them and they are defragmented. By simply selecting these files as Excluded files, these will be ignored and untouched by the defrag methods. If he wants them moved to the inner tracks first, he can make them the only files in the archive. He could then Defrag to move them to the inner tracks. Then he could remove them from the Archived file list and add them to the Exclude list. These files will then be out of the way and completely ignored in subsequent defrags.

Enable Boot Time Defragmentation. Certain files cannot be defragged during normal operations. In the current versions of Windows, such files include pagefile.sys, hiberfile.sys, the event files, and other system metafiles. In order to defrag and place these files, it typically needs to be done using an offline process. In this implementation of the present invention, offline defrags are performed during the system boot process. Typically, it is not often that a user will need to perform an offline defrag. But if he wishes to do an offline defrag, he can select Offline Defrag for the specific drive or drives he has selected, and his system will perform an offline defrag on the next boot during the boot process. After the Offline Defrag is performed, the Offline Defrag setting will revert to a deselected state. In an alternate embodiment, these files are checked at every boot for the necessity of being moved and defragmented.

Respect Layout.ini. The current versions of the Microsoft Windows operating system are constantly adjusting themselves for best performance, and in doing so create a file called layout.ini which contains an optimal file layout for a drive as far as predicted fastest program launching and fastest boot performance. Currently, the layout.ini file is located in the Prefetch Folder in the Windows directory. Currently, every 3 days Windows performs a boot optimize and uses elements of the layout.ini file to layout the files. This however is only a partial attempt. Not all files listed in the layout.ini file are optimized and they are not automatically placed in the fastest section of a hard drive. The present invention has the option to read the layout.ini file and exhaustively layout files according to optimal file layout.

When a user has the “Respect Layout.ini” option checked, the optimal file layout is laid out at the very beginning of the hard drive and in the exact order as suggested by the layout.ini file. File access for the most commonly used files will then typically be the absolute fastest that it can be for the system since all sequential file access patterns when launching a program and booting your system are taken into account. Note though that when Respect Layout.ini is currently selected, it is considered a High Performance option so if a user just wants the present invention to layout the files in his layout.ini file only, then he can select Complete High Performance Then Stop under any defrag method.

FIG. 17 is a diagram illustrating the defragmentation controls shown in FIG. 12 in more detail. The GUI interface has a set of defragmentation controls down the left side of the screen, to the left of the True Disk metaphor display 100. There is a menu control bar 140 across the top, containing: “Defragmentation” 142; “View” 144; “Tools” 146; and “Help” 148 pull down menus. Below the menu control bar is a disk drive selection box 102. This is followed by drive information 103 for the disk drive selected. Below this is a defrag method selection 104, followed by Start and Pause buttons 105. And below these buttons is the cluster analysis box 106.

The disk drive selection box 102 contains one or more disk drives 110, one of which may be selected to work on. Each such disk drive corresponds to logical disk drive, which in turn corresponds to a disk partition, with the understanding that many disk drives only contain one partition. Each disk 110 in the disk selection box 102 has its drive letter to the left, followed by a status to the right. In the example shown, C: drive is shown as “Analyzed” and D: drive is shown as “Ready”. When a disk is undergoing analysis, it is designated as “Analyzing” with a percentage complete to the right. When a disk is undergoing defragmentation, it is designated as “Defragmenting” with a percentage complete to the right. After having completed defragmentation, a disk is designated as “Completed”.

Below the disk drive selection box 102 is the drive status display 103. At the top is the name of the disk drive, in this case, the default “Drive C:”. To the right of that is the Analyze button 112 discussed above. Below that are three sets of file counts and byte counts: Total files/bytes 114; Contiguous files/bytes 115; and Fragmented files/bytes 116. Below this is a “Degree of Fragmentation” showing the percentage of fragmented files, followed by a bar showing this same information.

This is followed by a Defrag Method section 104 that lists various methods that can be invoked for defragmenting a disk. Each method has a radio button to the left, the name for the type of defragmentation in the middle, and in most cases, an Option button to the right. In this implementation, only a single defragmentation method can be selected at any time, and thus, when one radio button is selected, the previous button selected is cleared. In this implantation, the defragmentation methods are listed as follows: “Fragmented files only” 120; “Consolidate” 122 with Options 123; “Folder/File name” 124 with Options 125; “Recency” 126 with Options 127; and “Auto” 128 with Options 129. Below the Defrag Methods 104 is located a Maximum Resource Usage % selector 130 which allows a user to limit the amount of system resources that the present invention can utilize when operating. Below this are the activation buttons 105: a Start button 132; and a Pause button 133. Shown below the activation buttons 105 is the cluster or block status box 106 discussed above.

Defrag Methods. The following describes various Defrag Methods:

Auto Defrag (OptiSeek). If a user is not a power user and simply wants the most efficient, hands-off, yet intelligent, defrag method then he can choose the AUTO method 128. The Auto method 128 uses this inventions novel OptiSeek technology to automatically tune the performance of a hard drive to achieve absolute optimum performance for most file accesses.

OptiSeek aims to achieve file access performance that is closely equal to the minimum seek time for a hard drive (also known as track-to-track) seek. For most current hard drives today, this is around 2 milliseconds. For faster drives, it is less. Nevertheless, in the present embodiment, it has been arbitrarily cut this off at 2 milliseconds.

When a user selects options 129 for the Auto Method 128, the present invention automatically decides the percentage of the file system to be divided for the fast outer tracks and slow inner tracks. The default figures is designed to provide an Average Seek Time of 2 milliseconds. If the user adjusts the performance slider to the left, the percentage of files that go to the outer tracks increases and the Average Seek Time increases.

The current cost of having the performance set to Optimum typically is slightly longer defrag times due to a little more flux between files that may get exchanged between Archive and High Performance zones due to regular computer usage. Dragging the slider downwards for slightly slower performance will current typically provide slightly faster defrags but with slightly slower than optimal performance. If a user is unsure, he can simply leave it at the default settings where the slider is set to Optimum.

It is also advantageous in many cases that users select to Place Directories Next To MFT since this will typically give them fastest file access performance. Note that as a hard drive fills over time, the percentage of files to High Performance and Archive zones typically changes. This is because OptiSeek aims to optimize seek times to achieve that minimum seek time of 2 mS.

The AUTO method 128 performs a simple Consolidate defrag which only moves the files necessary to defrag all files and pack all the files without any free space between files to the outer tracks. The inner tracks may contain some “holes” between data but this is not critical to performance since this area is generally untouched during normal computer use.

Other Defrag Methods

The present invention's defrag methods, coupled with the powerful High Performance and Archive Options give a user significant flexibility and enables him to defrag his drives—any way he wants to or by whatever method his computer use dictates.

Five main defrag methods are provided in the current embodiment of the present invention. All but one of these defrag methods have further customizable options. With the further customizable options a total of 35 different combinations for defragging are currently available.

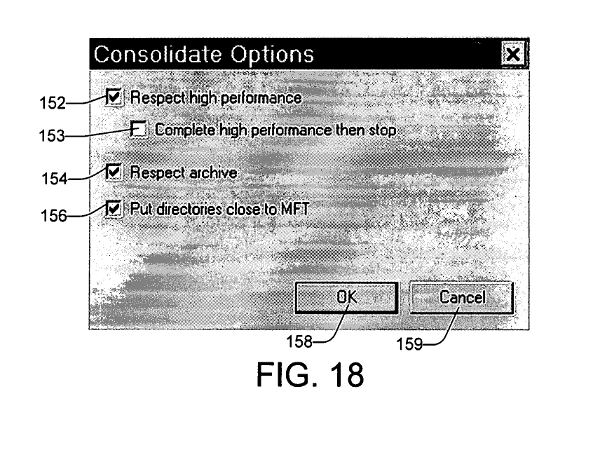

FIG. 18 is a diagram illustrating an Options screen that is launched when a user clicks on one of the Defrag Method option buttons 123, 125, 127, 129 shown in FIG. 17. In each of these methods, the following 3 options recur:

### 1. Respect High Performance 152

a. Complete High Performance Then Stop 153

### 2. Respect Archive 154

3. Put Directories adjacent to the MFT 156

The first option, “Respect High Performance” 152 conforms to or “respects” the High Performance options previously set for the disk. Similarly, the “Respect Archive” option 154 conforms to or “respects” the Archive options previously set for the disk. In either case, if the “respect” option is not set, the appropriate settings will be ignored. This implementation never ignores the Exclude settings if there are files to be excluded. When Respect High Performance 152 and/or Respect Archive 154 are selected for any defrag method, the appropriate actions will be performed first followed by the algorithm of each specific method.

Option 3, “Put Directories Adjacent to the MFT” 156, attempts to do just that, moving directories adjacent to the Master File Table (MFT), in order to minimize seek times when accessing those directories. Placing directories close to MFT can significantly improves hard drive performance since there is often a lot of dialog between the MFT (Master File Table) and the Directories regarding information on the files on a drive before they are fetched. Having these adjacent to each other can often vastly reduces seek times for these transactions.

Complete High Performance Then Stop. The Complete High Performance Then Stop option 153 can be used if a user is only concerned with processing his high performance files. When he is using this option, it is often preferable to deselect options 2 (Respect Archive) and 3 (Put Directories Adjacent to the MFT). The present invention will then simply process High Performance options and then stop.

Folder/Filename Method. The Folder/Filename method 124 will attempt to layout files on a hard drive according to Folder Name Order, and then within each folder, the files are sorted based upon name order. If a user wants to override and manually determine the folder order, he can do this in the High Performance options where he can manually drag and drop folders into the order he wants. He then should probably set the Respect High Performance option for this manual sort to take effect. Files and/or Folders that qualify for Archive will typically be moved to inner tracks when Respect Archive is selected. The files that are not moved to the inner tracks will then be sorted.

This method of ordering files on a hard drive will often promote performance since files are sorted in strict order, and directory look ups are often faster when in alphabetical order. Adjacent track seeks and instantaneous seeks are often achieved since often DLL and other data files are called upon by programs in alphabetical order.

Recency The Recency option 126 provides extensive flexibility in ordering files based upon last access dates or modify dates. This method is often well suited for drives that may consist primarily, if not exclusively, of data files, such as in a file server situation. This method can also be advantageous for situations where a hard drive is getting full and a user desires good performance for particular files, with room to grow, and with fast subsequent defrags.

If required, this method can provide the ability to place all of the files on a hard drive starting at the inner tracks and working outwards. This may be ideal for data drives that are getting full but contain data that is rarely accessed or modified.

Two additional options are provided. Align to end options start from the inner tracks and work outwards—align to beginning options start at the outer tracks and work inwards. A user can also decide the order—oldest to most recent, or vice versa.

If a disk is 80% full, and contains mostly (or only) data, a user can put his oldest files to the inner tracks and then order to most recent, so that the most recent files will be around 20% in from the outer tracks. His most often required data will then typically be about 20% in from the outer tracks and the space on the outer side of this will be empty. Disk reads and writes will then typically be fairly fast, and, importantly, subsequent defrags will typically be faster since older data is in the inner tracks.

Finally, a user might not need to “respect” Archive and High Performance with this method but the option is there if desired.

Consolidate. The Consolidate option 123 is what most defraggers currently already do. They pack the data towards either the inner or the outer tracks of a drive but, it is typically an all inclusive affair, so that a drive that is almost full still experiences drive fatigue, since there is no “order” to the files and no preferential placement of frequently accessed files.

However, the present invention provides the options of the Archive and High Performance optimizing so that a user still can get his High Performance Files to the outside tracks and Archive files to the inner tracks. When a user's most and least important files are where he wants them, then what happens with the remaining files is typically not as important, and these files can just be consolidated without noticeable loss of performance.

So if High Performance requirements and Archive requirements are in place, then a user can use this method to take care of the remainder of his files, often with minimal overhead. Files are typically sorted in no particular method, but are defragged and consolidated—after the High Performance files have been defragged and consolidated first. Defrags using this method are typically quick and performance can be excellent.

If a user just wants to defrag without all of the extra file placement and is happy with having a less than optimum file ordering, then he can accomplish this using the present invention to just perform a Consolidate mode defragger on a regular basis. The result is similar to that provided by the Windows XP native defragger.

If a user just wishes to Consolidate, then the Archive option can used in conjunction with this method to often significantly improves performance, since about 80% of most users' files are typically archived. This then only leaves the drive to have to work through about 20% of his data when loading files. So he can significantly improve his resulting seek confinement, regardless. Defrags with Consolidate and Archive and Fast Archive are typically fairly fast and often can complete within minutes.

Fragmented Files Only. While the Fragmented Files Only method 120 will leave holes in data on a disk, if all a user requires is a quick defragmentation of fragmented files, this method is useful. He can simply select this option, and the present implementation will defrag all fragmented files in place, typically with rapidity and ease.

Other Options

Customizing Colors In Your Disk Display. A user can customize the colors of the blocks in the disk display to suit his preferences. This can be accomplished by simply clicking on the color in the legend bar, and then changing the color to suit. When he selects OK, the colors in the disk GUI will change for the particular file class he selected. This feature can also be found in the present embodiment under: Tools=>Options=>Advanced.

Maximum Resource Usage. A user can use the current implementation of the present invention to defrag while he is working on other things, while barely noticing that it is defragging in the background. This is done by simply setting the resource usage from anywhere between 1% to 100%, and this implementation of the present invention will not use more than the resources specified. The user can safely work while defragging is in progress. Selecting AUTO will automatically allocate system resources to the defragging process according to other demands and processes running on the system. This can be the ideal setting for someone who wishes to defrag while otherwise using the computer. Note thought that if other processes are using significant CPU and system resources, the defrag process could be slowed down.

Navigating The Disk Display. A user can navigate the disk display any time during a defrag with the arrow keys. Simply selecting any block and then using the arrow keys moves to the next or previous block (left and right arrows) or to the next (outer) or previous (inner) ring (up and down arrows). The contents of each block are displayed in the cluster analysis block 106.

Zooming The Disk Display. Simply right-clicking the mouse on the disk display and a user can zoom in or out, making the blocks smaller or larger. When zooming in, more blocks are shown, each with fewer file segments. Zooming out shows fewer blocks, each containing more files or file segments.

Scheduler. The current implementation of present invention also includes a schedule which enables a user to schedule defrag and optimization jobs to run whenever and on whatever schedule he wants them to run. Any schedules that are set are actually transferred to the Windows Task Scheduler in this implementation. As a result, the user may be required to set the password in the scheduled event in order for Windows to activate the scheduler. There is virtually unlimited flexibility in the schedules that a user can create.

File Highlighter: A useful feature for power users is the File Highlighter feature which a user can find in the Options Menu in the current implementation of the present invention. The File Highlighter enables a user to see where on the disk a specific file is located. When he selects the File Highlighter, the program will perform an analysis (if it has not already done so) and then display the file tree structure. Simply selecting a file or folder and pressing Highlight, and the clusters containing the file will flash 5 times. Files that are less than 1 Kb will often show that they are in the MFT. This is because NTFS currently typically stores files 1 Kb or smaller in the actual MFT itself.

The preceding disclosure referenced the Windows operating system, in its various current forms, since the current implementation was designed to operate in that environment. This is illustrative only, and the present invention includes similar functionality in other configurations and with other operating systems. Similarly, various Windows features and constructs have been mentioned, including the MFT, pagefile.sys, etc. Again, this is illustrative of the current implementation, and the present invention includes similar features for other operating systems. Also, the drawings show a single platter in a hard drive or disk that contains a single read/write arm. This is illustrative only, and other types of disk drives are also within the present invention. For example, disk drives may consist of multiple platters, with potentially read/write arms and heads on each side of each platter. Also, there may be multiple arms for the read/write heads for a given platter.

Those skilled in the art will recognize that modifications and variations can be made without departing from the spirit of the invention. Therefore, it is intended that this invention encompass all such variations and modifications as fall within the scope of the appended claims.

What is claimed is:

1. A method for reorganizing a storage device comprising:
representing a plurality of blocks of storage on the storage device as a set of concentric circles of blocks of storage with the concentric circles having a differing numbers of blocks of storage resulting in differing radii of the concentric circles; and
reorganizing the contents of the storage device utilizing the representation of the blocks of storage as a set of concentric circles of blocks of storage.

2. The method in claim 1 wherein:
the reorganizing comprises:
moving highly utilized files to circles of blocks of storage containing more blocks and moving less frequently used files to circles of blocks of storage containing fewer blocks.

3. The method in claim 1 wherein:
the reorganizing comprises:
defragmenting the storage device.

4. The method in claim 1 which further comprises:
displaying the representation of blocks of storage as the set of concentric circles to a user.

5. The method in claim 4 which further comprises:
displaying a contents of a specific block of storage to the user when the user selects the specific block of storage in the display of concentric circles of blocks of storage.

6. The method in claim 4 wherein:
the user is allowed to selectively display more or fewer blocks of storage in the displaying the representation of blocks of storage.

7. The method in claim 1 wherein:
the plurality of blocks of storage on the storage device represented as concentric circles of blocks of storage corresponds to a partition on the storage device.

8. The method in claim 1 wherein:
the method further comprises:
accepting reorganization preferences from a user; and
the reorganizing is responsive to the reorganization preferences accepted from the user.

9. The method in claim 8 wherein:
the reorganization preferences capable of being accepted comprise:
identifying files that should be moved to circles of blocks with greater numbers of blocks; and
identifying files that should be moved to circles of blocks with fewer number of blocks.

10. The method in claim 8 wherein:
the reorganization preferences capable of being accepted comprise:
identifying high performance files;
identifying archive files; and
identifying files to exclude in the reorganizing.

11. A computer software storage medium containing computer instructions for reorganizing a storage device, wherein the computer instructions comprise:
a set of computer instructions for representing a plurality of blocks of storage on the storage device as a set of concentric circles of blocks of storage with the concentric circles having a differing numbers of blocks of storage resulting in differing radii of the concentric circles; and
a set of computer instructions for reorganizing the contents of the storage device utilizing the representation of the blocks of storage as a set of concentric circles of blocks of storage.

12. The computer software storage medium in claim 11 wherein:
the reorganizing comprises:
moving highly utilized files to circles of blocks of storage containing more blocks and moving less frequently used files to circles of blocks of storage containing fewer blocks.

13. The computer software storage medium in claim 11 wherein:
the reorganizing comprises:
defragmenting the storage device.

14. The computer software storage medium in claim 11 wherein the computer instructions further comprise:
a set of computer instructions for displaying the representation of blocks of storage as the set of concentric circles to a user.

15. The computer software storage medium in claim 14 wherein the computer instructions further comprise:
a set of computer instructions for displaying a contents of a specific block of storage to the user when the user selects the specific block of storage in the display of concentric circles of blocks of storage.

16. The computer software storage medium in claim 14 wherein:
the user is allowed to selectively display more or fewer blocks of storage in the displaying the representation of blocks of storage.

17. The computer software storage medium in claim 11 wherein:
the plurality of blocks of storage on the storage device represented as concentric circles of blocks of storage corresponds to a partition on the storage device.

18. The computer software storage medium in claim 11 wherein:
the computer instructions further comprise:
a set of computer instructions for accepting reorganization preferences from a user; and
the reorganizing is responsive to the reorganization preferences accepted from the user.

19. A computer-implemented system capable of reorganizing a storage device comprising:
a means for representing a plurality of blocks of storage on the storage device as a set of concentric circles of blocks of storage with the concentric circles having a differing numbers of blocks of storage resulting in differing radii of the concentric circles; and
a means for reorganizing the contents of the storage device utilizing the representation of the blocks of storage as a set of concentric circles of blocks of storage.

20. The system in claim 19 which further comprises:
a means for displaying the representation of blocks of storage as the set of concentric circles to a user.
